(19) United States
(12) Patent Application Publication
(10) Pub. No.: US 2020/0207359 A1
(43) Pub. Date: Jul. 2, 2020

(54) SMART DRIVING MANAGEMENT SYSTEM AND METHOD

(71) Applicant: SOUTHERN TAIWAN UNIVERSITY OF SCIENCE AND TECHNOLOGY, Tainan City (TW)

(72) Inventors: CHING-CHOU TANG, TAINAN CITY (TW); CHIEN-LIANG HSIEH, TAINAN CITY (TW); KUN-YU LI, TAINAN CITY (TW); JHIH-DENG HONG, TAINAN CITY (TW)

(21) Appl. No.: 16/233,352

(22) Filed: Dec. 27, 2018

(51) Int. Cl. B60W 40/09; G07C 5/00; G07C 5/08; B60W 50/14; G06F 3/16; G10L 15/18; B60K 35/00; G06K 9/00

(52) U.S. Cl. CPC B60W 40/09; G07C 5/008; G07C 5/0808; G07C 5/0833; B60W 50/14; G06F 3/167; B60W 2520/10; B60K 35/00; G06K 9/00845; B60K 2350/1044; B60W 2050/143; B60W 2540/12; G10L 15/1822

(57) ABSTRACT

A smart driving management system and a method are disclosed. The management system includes a central control unit, a detection module, a voice reminding module, and a reply receiving module. The management method includes: A. providing a management system communicating with an automotive electronic diagnosis unit of a vehicle to receive driving information of the vehicle detected by the automotive electronic diagnosis unit; B. the management system setting a standard value for the driving information and sending out a voice message when detecting that data of the driving information does not meet the standard value; C. the management system receiving a voice reply content and detecting whether data of new driving information meets the standard value according to the voice reply content; D. the management system generating a detection result based on the new driving information and determining that the detection result is normal driving or dangerous driving.

### FIELD OF THE INVENTION

The present invention relates to a smart driving management system and a smart driving management method for determining whether it is normal driving or dangerous driving according to the driving information of the driver and for collecting and recording the data as big data for future use to ensure the safety of the passenger.

### BACKGROUND OF THE INVENTION

Because the performance of vehicles is getting better and better, the relative driving requirements of the driver are extremely strict, so as to ensure the safety of the driver and the passengers. However, the driving behavior of every driver is different. Due to negligence, wrong operation, fatigue driving or drunk driving, there are many traffic accidents. Due to the limited capacity of traffic accident identification equipment and police identification and records officers, it is not possible to determine all traffic accidents effectively and accurately. Therefore, it is difficult to clarify the responsibilities of both parties, which may affect follow-up insurance claims.

Chinese Patent Publication No. CN103425733A, entitled “dialogue device, dialogue system, and dialogue control method” published on Dec. 4, 2013, discloses a dialog device configured to communicate with a driver driving a vehicle. The dialog comprises a storage unit, a concentration measurement unit, and a dialogue unit. The storage unit is configured to save a preference database in which a dialog option and a dialogue effect are associated with each other. The dialog option is an option for the content of the conversation with the driver. The dialogue effect indicates the degree to which the driving concentration of the driver is improved. The concentration measurement unit is configured to measure the driving concentration of the driver. The dialog unit is configured to select the dialog option based on the dialog effect in the preference database when the concentration measured by the concentration measurement unit decreases below a predetermined threshold. The dialog is then performed with the selected dialog option. The dialogue effect of the conversation is calculated based on the concentration before and after performing the conversation, and the dialogue effect of the preference database is updated.

The above patent uses the content of the language dialogue to attract the attention of the driver so as to improve the driving concentration by means of the topic of interest to the driver. However, it can only improve the concentration of the driver, and cannot correct the operation error of the driver, drunk driving or illegal driving effectively, so it is not ideal for use.

Chinese Utility Model Publication No. CN205130938U discloses a “car safety driving detection device” published on Apr. 6, 2016. During the driving, the speed sensor transmits the vehicle speed information to the central processor in time and then outputs a signal to the vehicle operating mechanism controller and the alarm module to send a voice warning to the driver through the speaker. The driver can respond accordingly via the microphone. The voice interaction module analyzes the speech rate, intonation and tone of the driver, and compares it with the information in the DRAM memory, and outputs a corresponding execution signal for normal driving or deceleration to the vehicle operating mechanism controller via the central processor.

The above patent can instantly detect whether the driver is distracted, speeding or fatigued and give corresponding warning information. If necessary, the vehicle can be forced to slow down, which helps to reduce the incidence of traffic accidents. However, the above patent only evaluates the driver's “state” based on the content of the reply, and does not further evaluate whether the driver has eliminated dangerous driving action based on the comparison of the car body condition. Therefore, it is not possible to effectively record whether the various driving behaviors of the driver are inappropriate, as a reference basis for calculating the amount of premiums when the driver is insured in the future, or as a judgment reference for the responsibility of an accident. Besides, the above patent does not detect the passage state to meet the needs of the passenger or to protect the safety of the passenger. Therefore, there are still deficiencies in use.

### SUMMARY OF THE INVENTION

In view of the above shortcomings of the prior art, the primary object of the present invention is to provide a smart driving management system and a smart driving management method.

The smart driving management system of the present invention comprises a central control unit, a detection module, a voice reminding module, a reply receiving module, and an ID identification module. The central control unit communicates with an automotive electronic diagnosis unit in a vehicle to receive driving information of the vehicle detected by the automotive electronic diagnosis unit. The detection module is electrically connected to the central control unit. The detection module sets a standard value for the driving information. When the detection module detects that data of the driving information does not meet the standard value, the central control unit sends out a voice message. The voice reminding module is electrically connected to the central control unit. The voice reminding module receives and plays the voice message. The reply receiving module is electrically connected to the central control unit. The reply receiving module is configured to receive a voice reply content, and the voice reply content is transmitted to the central control unit. The central control unit receives new driving information of the vehicle detected by the automotive electronic diagnosis unit according to the voice reply content. The detection module detects whether data of the new driving information meets the standard value. The central control unit generates a detection result and determines that the detection result is normal driving or dangerous driving. The ID identification module is electrically connected to the central control unit for performing identification through a biometric identification technology.

Preferably, the voice reminding module is provided with a smart speaker for playing the voice message. The smart speaker is provided with a backup power supply. When the smart speaker is turned off improperly, the backup power supply supplies power to start the smart speaker again, and the voice message that the smart speaker is going to be turned off is played for reminding.

Preferably, when the reply receiving module does not receive the voice reply content within an interval, the voice reminding module repeatedly plays the voice message until the reply receiving module receives the voice reply content.

Preferably, the smart driving management system further comprises a signal transmitting module. The signal transmitting module is electrically connected to the central control unit. The signal transmitting module is configured to receive and record the detection result. The detection result with recorded content is outputted to a cloud server for recording.

The smart driving management method of the present invention comprises the following steps: A. providing a smart driving management system communicating with an automotive electronic diagnosis unit in a vehicle to receive driving information of the vehicle detected by the automotive electronic diagnosis unit; B. the smart driving management system setting a standard value for the driving information and sending a voice message when detecting that data of the driving information does not meet the standard value; C. the smart driving management system receiving a voice reply content and detecting whether data of new driving information meets the standard value according to the voice reply content; D. the smart driving management system generating a detection result based on the new driving information and determining that the detection result is normal driving or dangerous driving.

Preferably, the smart driving management method further comprises a step E. the smart driving management system recording the detection result, and the detection result with recorded content being outputted to a cloud server for recording.

Preferably, the driving information includes a vehicle state, a driver state, and a passenger state. The vehicle state includes whether any component of the vehicle is abnormal or faulty. The driver state includes one of an emotion identification, a driving behavior, a vehicle speed, a brake message, a lane deviation, a detection distance of a radar and a vehicle lens image, or a combination thereof. The passenger state includes designating a service item or sending a help message.

Preferably, in the step C, when the smart driving management system does not receive the voice reply content within an interval, the smart driving management system repeatedly plays the voice message until the smart driving management system receives the voice reply content.

Preferably, in the step c, after the smart driving management system receives the voice reply content, the smart driving management system parses the semantic meaning of the voice reply content and determines whether the semantic meaning of the voice reply content corresponds to the semantic meaning of the voice message sent. If the semantic meaning of the voice reply content corresponds to the semantic meaning of the voice message, the smart driving management system detects the data of the new driving information again.

Preferably, wherein after the smart driving management system terminates the step D, the smart driving management system starts a second detection again, and the detection is continuously performed according to this cycle mode until an engine of the vehicle is turned off to stop driving.

Preferably, in the step D, when the data of the new driving information meets the standard value, it is determined that the detection result is normal driving; when the data of the new driving information does not meet the standard value, it is determined that the detection result is dangerous driving.

Preferably, items of the dangerous driving include one of speeding, running a red light, running level crossing against railing signals, snaking, changing lanes arbitrarily, improper braking, wrong shifting time, turning without direction lights, not turning on headlights, not having a safe distance, not paying attention to pedestrians and not paying attention to obstacles or a combination thereof. The items of the dangerous driving are detected by a sensor or an advanced driver assistance system.

Preferably, in the step A, for starting an engine of the vehicle, a biometric identification technology of an ID identification module is used to identify and confirm whether the driver is the real driver of the vehicle.

Preferably, in the step B, when the vehicle is detected to be traveling on an unscheduled route, the vehicle stalls for no reason or the time that the vehicle stays at any place exceeds the set standard value, the voice message is sent for warning. In the step c, after the voice reply content is replied, when the smart driving management system parses the semantic meaning of the voice reply content as a help, the smart driving management system immediately sends an alarm for rescue.

Preferably, in the step c, after the voice reply content is replied, when the smart driving management system parses the semantic meaning of the voice reply content as a designated shopping, the smart driving management system sends out a notification that goods are delivered to a designated place according to a service item of the designated shopping.

Preferably, in the step B, the automotive electronic diagnosis unit detects whether a vehicle state of the vehicle is abnormal to confirm whether all components of the vehicle are normal, if there is an abnormality, the voice message that the vehicle malfunctions is sent.

Preferably, in the step C, the smart driving management system directly communicates an APP in a mobile phone to open a vehicle door and a vehicle window and to sound for help.

The above technical features have the following advantages:

1. The driving information of the driver can be detected to generate a detection result, and the detection result is output to the cloud server and recorded. This can prove that the driver is in a knowing situation to generate the dangerous driving behavior, as a reference basis for calculating the amount of premiums of the insurance company in the future, or as a judgement reference for the responsibility of an accident.

2. By continuously detecting the driving behavior of the driver and correcting the dangerous driving behavior of the driver through continuous voice reminders, it is possible to reduce illegal driving, wrong driving and inadvertent driving and to improve vehicle performance. All driving information of the driver is collected, analyzed, judged and recorded as big data for future use.

3. It can effectively prevent the dangerous driving of the driver, such as speeding, running a red light, running level crossing against railing signals, snaking, changing lanes arbitrarily, turning without direction lights, not turning on headlights, not having a safe distance, improper braking, wrong shifting time, lane deviation, not paying attention to pedestrians or not paying attention to obstacles.

4. Furthermore, it is possible to detect whether the passenger state of the passenger during the driving is abnormal at any time, thereby ensuring the personal safety of the passenger while driving.

5. Furthermore, the automotive electronic diagnosis unit can detect whether the vehicle state of the vehicle is abnormal, thereby confirming whether all components of the vehicle are normal. If there is an abnormality, the voice message of the vehicle failure will be sent to remind the driver and the passenger of paying attention.

### BRIEF DESCRIPTION OF THE DRAWINGS

FIG. 1 is a block diagram of a smart driving management system according to an embodiment of the present invention;

FIG. 2 is a flow chart of a smart driving management method according to an embodiment of the present invention; and

FIG. 3 is a flow chart showing the detection of the driving information of the smart driving management method according to an embodiment of the present invention.

### DETAILED DESCRIPTION OF THE PREFERRED EMBODIMENTS

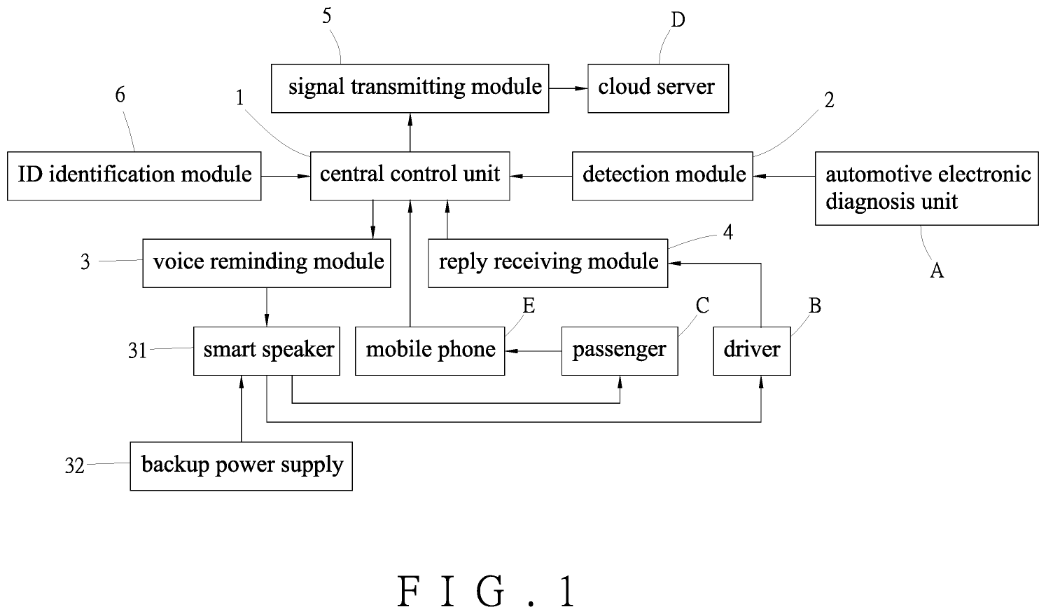

Referring to FIG. 1, a smart driving management system in accordance with an embodiment of the present invention comprises a central control unit (1), a detection module (2), a voice reminding module (3), a reply receiving module (4), a signal transmitting module (5), and an ID identification module (6).

The central control unit (1) is installed in a vehicle and is in communication with an automotive electronic diagnosis unit (A) in the vehicle for continuously receiving driving information of the vehicle detected by the automotive electronic diagnosis unit (A). The central control unit (1) may be an onboard diagnostic system (OBDII). The driving information includes a vehicle state of the vehicle, a driver state of a driver (B), and a passenger state of a passenger (C). The vehicle state includes whether any component of the vehicle is abnormal or faulty. The driver state includes the data of an emotion identification of the driver (B), a driving behavior, a vehicle speed, a brake message, a lane deviation, a detection distance of a radar, a vehicle lens image, and so on. The passenger state includes a designated service item of the passenger (C) and whether the passenger is in danger, such as shopping or sending a help message.

The detection module (2) is electrically connected to the central control unit (1). The detection module (2) sets a standard value for the driving information. When it is detected that the data of the driving information does not meet the set standard value, a voice message is sent via the central control unit (1). For example, the standard value is set as a vehicle speed of 110 km/h. When the detection module (2) detects that the vehicle speed detected by the automotive electronic diagnosis unit (A) exceeds 110 km/h, the central control unit (1) will send the voice message. The content of the voice message indicates the value of the current vehicle speed to remind the driver (B) and the passenger (C) that the current vehicle speed has exceeded the standard value and that the vehicle should slow down. For example, the standard value is set as a safe distance of more than 50 m between the vehicle and a front vehicle. If it is detected that the safe distance of the vehicle is less than 50 m, the voice message “should keep a safe distance” will be sent. For example, if the low gear (3 gear or less) is not used during the up and down slopes or the wrong shifting time of the high gear (4 gear or more), the voice message “should be shifted properly” will be sent. The detection module (2) further detects whether the driving state of the driver (B) and the passenger state of the passenger (C) are abnormal. For example, when the vehicle has not reached the destination, that is, when the vehicle stalls for no reason or the time that the vehicle stays at any place exceeds the set standard value, the central control unit (1) will send the voice message to remind the driver (B) or the passenger (C) that it is necessary to give a correct voice reply content to confirm whether there is any abnormality. The detecting module (2) further detects whether the vehicle state of the vehicle is abnormal through the automotive electronic diagnosis unit (A) to confirm whether all components of the vehicle are normal. If there is an abnormality, the voice message of the vehicle failure will be sent to remind the driver (B) and the passenger (C) of paying attention.

The voice reminding module (3) is electrically connected to the central control unit (1). The voice reminding module (3) receives the voice message sent by the central control unit (1) and plays it. The voice reminding module (3) is electrically connected to a smart speaker (31) or a speaker device in the vehicle, so that the voice message can be played to remind the driver (B) or the passenger (C) of paying attention. The smart speaker (31) may be provided with a backup power supply (32). When the smart speaker (31) is turned off improperly, the backup power supply (32) supplies power to start the smart speaker (31) again. When the smart speaker (31) is turned off improperly, the voice message that the smart speaker (31) is going to be turned off is played to remind the passenger (C) of paying attention.

The reply receiving module (4) is electrically connected to the central control unit (1). The reply receiving module (4) receives a voice reply content of the driver (B) or the passenger (C) and transmits the voice reply content to the central control unit (1). If the driver (B) or the passenger (C) does not give any voice reply content within an interval, the voice reminding module (3) will repeatedly play the voice message until the reply receiving module (4) receives the voice reply content of the driver (B) or the passenger (C). For example, the voice reply content that the driver (B) replies is “knowing speeding and slowing down”. After receiving the voice reply content, the central control unit (1) parses the semantic meaning of the voice reply content and confirms whether it corresponds to the semantic meaning of the voice message sent. If it corresponds to the semantic meaning of the voice message, the central control unit (1) receives new driving information of the vehicle detected by the automotive electronic diagnosis unit (A) according to the voice reply content. The detection module (2) detects whether the data of the new driving information meets the set standard value, and the central control unit (1) generates a detection result according to the detection. For example, the detection module (2) detects whether the vehicle speed is reduced less than the standard value of 110 km/h. If the vehicle speed is less than 110 km/h, it is determined that the detection result is normal driving and the detection is terminated. If the vehicle speed is not less than 110 km/h, the central control unit (1) will determine that the detection result is dangerous driving and the detection is terminated. After terminating the detection, the central control unit (1) starts a second detection again. According to this cycle mode, the detection is continuously performed until the engine of the vehicle is turned off to stop driving, and then the detection is stopped. For example, when the voice reply content that the passenger (C) responds to the reply receiving module (4), includes shopping or a help message, the central control unit (1) parses the semantic meaning of the voice reply content and confirms whether it corresponds to the semantic meaning of the voice message after receiving the voice reply content. If it corresponds to the semantic meaning of the voice message, the central control unit (1) proceeds to the next step according to the voice reply content, for example, performing a notification that goods are delivered to the designated place according to the specified service item, sending an alarm for rescue according to the help message.

The signal transmitting module (5) is electrically connected to the central control unit (1). The signal transmitting module (5) receives the detection result generated by the central control unit (1) and records it, and outputs the detection result and the recorded content to a cloud server (D) for recording as a reference basis for calculating the amount of premiums of the insurance company in the future, or as a judgement reference for the responsibility of an accident, or performing a notification that goods are delivered to the designated place according to the specified service item, or sending an alarm for rescue according to the help message.

The ID identification module (6) is electrically connected to the central control unit (1). The ID identification module (6) uses a biometric identification technology to identify whether the driver (B) is the real driver of the vehicle. If the driver (B) is not the real driver of the vehicle, the ignition system of the vehicle will be locked, so it is unable to start the engine of the vehicle. The biometric identification technology includes at least one of acoustic identification, fingerprint identification, iris identification, and face identification. The ID identification module (6) further identifies the difference between the driver (B) and the passenger (C).

The items of the dangerous driving of the above detection result include speeding, running a red light, running level crossing against railing signals, snaking, changing lanes arbitrarily, turning without direction lights, not turning on headlights, not having a safe distance, improper braking, wrong shifting time, lane deviation, not paying attention to pedestrians or not paying attention to obstacles. The invention mainly utilizes continuous detection of the driving behavior of the driver (B) and continuous voice reminding, thereby correcting the dangerous driving behavior of the driver (B) to reduce illegal driving (for example: speeding, running a red light, running level crossing against railing signals, snaking, changing lanes arbitrarily, turning without direction lights, not turning on headlights, or not having a safe distance), wrong driving (for example: improper braking, wrong shifting time) and inadvertent driving (for example: lane deviation, not paying attention to pedestrians or not paying attention to obstacles) and to improve vehicle performance (for example, reminding the driver of shifting properly by means of a voice message). At the same time, all driving information of the driver (B) is collected, analyzed, judged and recorded as big data for future use. For example, when calculating the premium, it can refer to the number of times the driver (B) has dangerous driving to consider whether to increase the premium or not, or when clarifying the responsibility of the accident, it can be used to prove that the driver (B) is in a knowing situation to act the above dangerous driving behavior. The items of the above-mentioned dangerous driving are detected by a sensor or an advanced driver assistance system (ADAS). The present invention further detects whether an abnormality has occurred in the passenger state of the passenger (C) to ensure the safety of the passenger (C). The smart speaker (31) can play different voice messages for different states to train the driver (B) to give a correct voice reply content to recognize the emotion of the driver (B), playing the role of manual customer service.

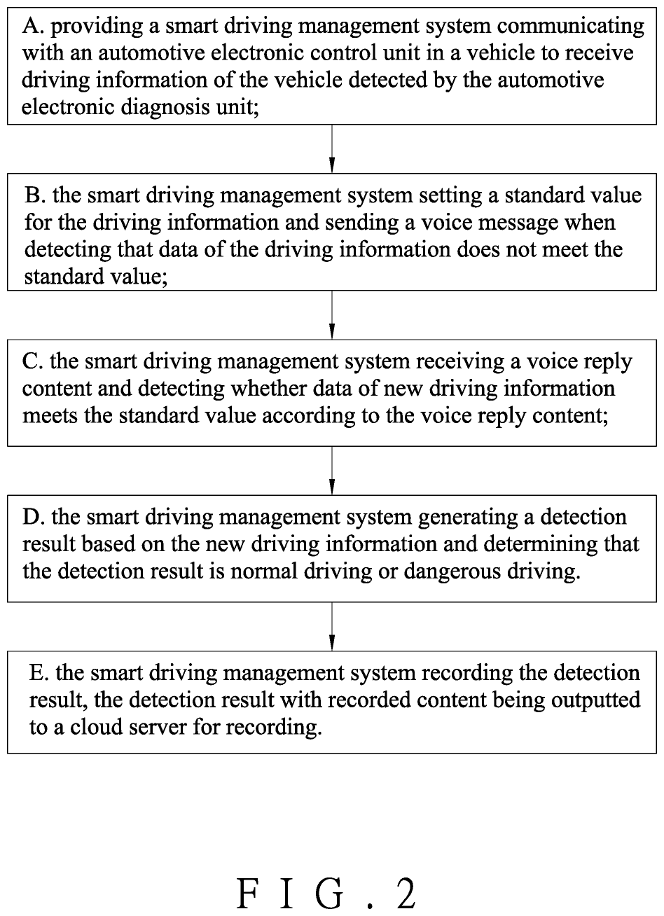

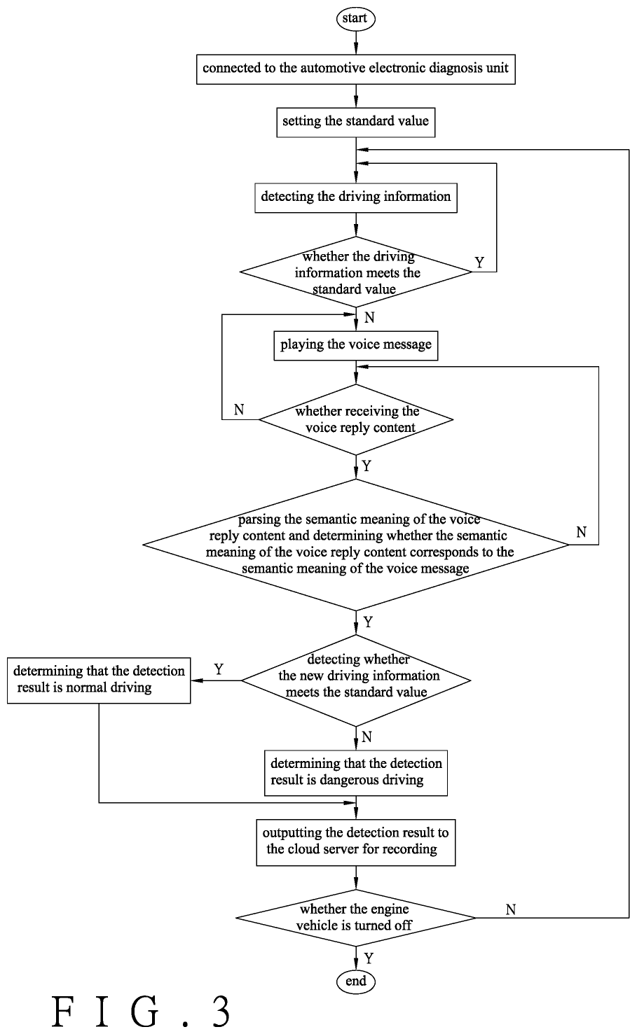

FIG. 2 and FIG. 3 illustrates a smart driving management method in accordance with an embodiment of the present invention, which is described by taking a driver (B) driving a taxi to carry a passenger (C) as an example, in cooperation with the above smart driving management system (please refer to FIG. 1), comprising the following steps:

A. A smart driving management system is connected to an automotive electronic diagnosis unit (A) in a vehicle to receive driving information of the vehicle detected by the automotive electronic diagnosis unit (A). The driving information includes a vehicle state, a driver state, and a passenger state. The vehicle state includes whether any component of the vehicle is abnormal or faulty, such as abnormal power output, abnormal pressure, abnormal lights, abnormal temperature, oil leakage, and so on. The driver state includes the data of a driving behavior, a vehicle speed, a brake message, a lane deviation, a detection distance of a radar, a vehicle lens image, and so on. The passenger state includes a designated service item and whether the passenger is in danger, such as shopping or sending a help message. When the driver (B) wants to start the engine of the vehicle, he/she needs to first use the biometric identification technology of the ID identification module (6) to identify and confirm whether the driver (B) is the real driver of the vehicle to avoid illegal use by others for driving the vehicle to commit a crime. When the driver (B) starts the engine of the vehicle, the smart driving management system is immediately activated to start the smart driving management method to detect the data of all driving information under the operation of the driver (B) while driving. The automotive electronic diagnosis unit (A) is used to detect whether the vehicle state of the vehicle is abnormal to confirm whether all components of the vehicle are normal.

B. The smart driving management system sets a standard value for the driving information and sends a voice message when it detects that the data of the driving information does not meet the standard value. When the vehicle starts to travel, the various data of the above-mentioned driving information are generated. A central control unit (1) of the smart driving management system controls a detection module (2) to be activated to set a standard value for the driving information. For example, the standard value of the set vehicle speed is 110 km/h or less. When the detection module (2) detects that the vehicle speed detected by the automotive electronic diagnosis unit (A) exceeds 110 km/h, a voice reminding module (3) of the smart driving management system will send the voice message through a smart speaker (31). The voice message indicates the value of the current vehicle speed to remind the driver (B) and the passenger (C) that the current vehicle speed has exceeded the standard value and to send a warning voice to slow down. While driving, if the driver (B) intends to harm the passenger (C), for example, if the driver (B) deliberately travels on an unscheduled route, that is, not to the destination, the smart speaker (31) will send out a warning voice message “not in the scheduled route” to remind the driver (B) and the passenger (C) of paying attention. For example, when the driver (B) has not reached the destination, that is, if the vehicle stalls for no reason or the time that the vehicle stays at any place exceeds the set standard value, a warning voice message “the vehicle stays too long” will be sent to remind the driver (B) and the passenger (C) of paying attention.

C. The smart driving management system receives a voice reply content and detects whether the data of the new driving information meets the standard value according to the voice reply content. When the driver (B) hears the above voice message, he/she will reply with a voice reply content. For example, the voice reply content that the driver (B) replies is “knowing speeding and slowing down”. A reply receiving module (4) of the smart driving management system transmits the voice reply content to the central control unit (1) after receiving the voice reply content. The central control unit (1) parses the semantic meaning of the voice reply content and confirms whether it corresponds to the semantic meaning of the voice message sent. If it corresponds to the semantic meaning of the voice message, the central control unit (1) receives the new driving information detected by the automotive electronic diagnosis unit (A) according to the voice reply content. The detection module (2) detects whether the data of the new driving information meets the set standard value.

The detection module (2) further detects whether the driver state of the driver (B) and the passenger state of the passenger (C) are abnormal. For example, when the driver (B) goes beyond the scheduled route or stays too long or the vehicle stalls for no reason, as long as the voice reply content of the passenger (C) includes the meaning of “help”, when the central control unit (1) parses the semantic meaning of the voice reply content as a help, it will immediately send an alarm for rescue through the cloud server (D) according to the help message. At the same time, the passenger (C) can directly connect the central control unit (1) through an APP in a mobile phone (E) for controlling the opening of the vehicle door and the opening of the vehicle window and for controlling the smart speaker (31) to sound for help. When the smart speaker (31) is forcibly turned off by the driver (B), the passenger (C) can directly uses the backup power supply (32) to supply the required power to the smart speaker (31) through the APP in the mobile phone (E), such that the smart speaker (31) is forcibly activated to warn or deter the driver (B).

In addition, the passenger (C) can make an order for shopping via the voice reply content replied by the reply receiving module (4). For example, the passenger (C) will arrive at the destination after one hour, and the goods can be ordered in advance. When the central control unit (1) parses the semantic meaning of the voice reply content as shopping, the goods will be delivered to the destination through the cloud server (D) according to the specified service item for the passenger (C) to get the goods. A mobile payment may be made through the vehicle to pay for purchases or fares.

The driver (B) may reply to the corresponding voice reply content for the abnormal item of the vehicle state of the vehicle to confirm that it is known that the components of the vehicle malfunction and require immediate attention, disposal or repair.

D. The smart driving management system generates a detection result based on the new driving information, and the detection result is determined to be normal driving or dangerous driving. The central control unit (1) receives the new driving information, and the detecting module (2) detects whether the vehicle speed is less than the standard value of 110 km/h. If the vehicle speed is less than 110 km/h, it is determined that the detection result is normal driving and the detection is terminated. If the vehicle speed is not less than 110 km/h, the central control unit (1) will determine that the detection result is dangerous driving and the detection is terminated. After the central control unit (1) terminates the detection, it starts a second detection again. Detection is performed according to this cycle mode until the vehicle reaches the destination. When the engine of the vehicle is turned off to stop driving, the detection is stopped.

E. The smart driving management system outputs the detection result to a cloud server for recording. A signal transmitting module (5) of the smart driving management system receives the detection result generated by the central control unit (1) and records it, and outputs the detection result and the recorded content to a cloud server (D) for recording. It can be used to prove that the driver is in a knowing situation to act the above dangerous driving behavior, as a reference basis for calculating the amount of premiums of the insurance company in the future, or as a judgment reference for pursuing the responsibility of an accident to ensure the safety of the passenger (C).

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A smart driving management system, comprising:
a central control unit, communicating with an automotive electronic diagnosis unit in a vehicle to receive driving information of the vehicle detected by the automotive electronic diagnosis unit;
a detection module, electrically connected to the central control unit, the detection module setting a standard value for the driving information, wherein when the detection module detects that data of the driving information does not meet the standard value, the central control unit sends out a voice message;
a voice reminding module, electrically connected to the central control unit, the voice reminding module receiving and playing the voice message;
a reply receiving module, electrically connected to the central control unit, the reply receiving module being configured to receive a voice reply content, the voice reply content being transmitted to the central control unit, the central control unit receiving new driving information of the vehicle detected by the automotive electronic diagnosis unit according to the voice reply content, the detection module detecting whether data of the new driving information meets the standard value, the central control unit generating a detection result and determining that the detection result is normal driving or dangerous driving;
an ID identification module, electrically connected to the central control unit for performing identification through a biometric identification technology.

2. The smart driving management system as claimed in claim 1, wherein the voice reminding module is provided with a smart speaker for playing the voice message, the smart speaker is provided with a backup power supply, when the smart speaker is turned off improperly, the backup power supply supplies power to start the smart speaker again, and the voice message that the smart speaker is going to be turned off is played for reminding.

3. The smart driving management system as claimed in claim 1, wherein when the reply receiving module does not receive the voice reply content within an interval, the voice reminding module repeatedly plays the voice message until the reply receiving module receives the voice reply content.

4. The smart driving management system as claimed in claim 1, further comprising a signal transmitting module, the signal transmitting module being electrically connected to the central control unit, the signal transmitting module being configured to receive and record the detection result, the detection result with recorded content being outputted to a cloud server for recording.

5. A smart driving management method, comprising the following steps:
A. providing a smart driving management system communicating with an automotive electronic diagnosis unit in a vehicle to receive driving information of the vehicle detected by the automotive electronic diagnosis unit;
B. the smart driving management system setting a standard value for the driving information and sending a voice message when detecting that data of the driving information does not meet the standard value;
C. the smart driving management system receiving a voice reply content and detecting whether data of new driving information meets the standard value according to the voice reply content;
D. the smart driving management system generating a detection result based on the new driving information and determining that the detection result is normal driving or dangerous driving.

6. The smart driving management method as claimed in claim 5, further comprising a step E. the smart driving management system recording the detection result, the detection result with recorded content being outputted to a cloud server for recording.

7. The smart driving management method as claimed in claim 5, wherein the driving information includes a vehicle state, a driver state, and a passenger state; the vehicle state includes whether any component of the vehicle is abnormal or faulty; the driver state includes one of an emotion identification, a driving behavior, a vehicle speed, a brake message, a lane deviation, a detection distance of a radar and a vehicle lens image, or a combination thereof; the passenger state includes designating a service item or sending a help message.

8. The smart driving management method as claimed in claim 5, wherein in the step C, when the smart driving management system does not receive the voice reply content within an interval, the smart driving management system repeatedly plays the voice message until the smart driving management system receives the voice reply content.

9. The smart driving management method as claimed in claim 5, wherein in the step c, after the smart driving management system receives the voice reply content, the smart driving management system parses the semantic meaning of the voice reply content and determines whether the semantic meaning of the voice reply content corresponds to the semantic meaning of the voice message sent, if the semantic meaning of the voice reply content corresponds to the semantic meaning of the voice message, the smart driving management system detects the data of the new driving information again.

10. The smart driving management method as claimed in claim 5, wherein after the smart driving management system terminates the step D, the smart driving management system starts a second detection again, and the detection is continuously performed according to this cycle mode until an engine of the vehicle is turned off to stop driving.

11. The smart driving management method as claimed in claim 5, wherein in the step D, when the data of the new driving information meets the standard value, it is determined that the detection result is normal driving; when the data of the new driving information does not meet the standard value, it is determined that the detection result is dangerous driving.

12. The smart driving management method as claimed in claim 5, wherein items of the dangerous driving include one of speeding, running a red light, running level crossing against railing signals, snaking, changing lanes arbitrarily, improper braking, wrong shifting time, turning without direction lights, not turning on headlights, not having a safe distance, not paying attention to pedestrians and not paying attention to obstacles or a combination thereof; the items of the dangerous driving are detected by a sensor or an advanced driver assistance system.

13. The smart driving management method as claimed in claim 5, wherein in the step A, for starting an engine of the vehicle, a biometric identification technology of an ID identification module is used to identify and confirm whether the driver is the real driver of the vehicle.

14. The smart driving management method as claimed in claim 5, wherein in the step B, when the vehicle is detected to be traveling on an unscheduled route, the vehicle stalls for no reason or the time that the vehicle stays at any place exceeds the set standard value, the voice message is sent for warning; in the step c, after the voice reply content is replied, when the smart driving management system parses the semantic meaning of the voice reply content as a help, the smart driving management system immediately sends an alarm for rescue.

15. The smart driving management method as claimed in claim 5, wherein in the step c, after the voice reply content is replied, when the smart driving management system parses the semantic meaning of the voice reply content as a designated shopping, the smart driving management system sends out a notification that goods are delivered to a designated place according to a service item of the designated shopping.

16. The smart driving management method as claimed in claim 5, wherein in the step B, the automotive electronic diagnosis unit detects whether a vehicle state of the vehicle is abnormal to confirm whether all components of the vehicle are normal, if there is an abnormality, the voice message that the vehicle malfunctions is sent.

17. The smart driving management method as claimed in claim 5, wherein in the step C, the smart driving management system directly communicates an APP in a mobile phone to open a vehicle door and a vehicle window and to sound for help.
